(19) United States
(12) Patent Application Publication
(10) Pub. No.: US 2019/0257673 A1
(43) Pub. Date: Aug. 22, 2019

(54) Electromagnetic Six Degree of Freedom (6DOF) Tracking System With Non-Concentric Transmitter Coils

(71) Applicant: Sixense Enterprises Inc., Los Gatos, CA (US)

(72) Inventors: Igor Khalfin, Pleasanton, CA (US); Amir Rubin, Los Gatos, CA (US); Oded Y. Zur, Kochav-Yair (IL)

(21) Appl. No.: 16/282,722

(22) Filed: Feb. 22, 2019

Related U.S. Application Data
(60) Provisional application No. 62/634,177, filed on Feb. 22, 2018.

(51) Int. Cl. G01D 5/20; G06F 3/01

(52) U.S. Cl. CPC G01D 5/2086; G06F 3/011; G06F 3/012

(57) ABSTRACT

An electromagnetic tracking system with three non-concentric, non-parallel transmitter coils to generate the magnetic fields and sensor coils to generate magnetic sensor data, from which position and orientation of the sensor is determined. In one embodiment, the three non-concentric transmitter coils are attached to or mounted in a Head Mounted Display (HMD). Having the three transmitter coils be non-concentric reduces overall bulkiness and spreads the weight of the transmitter coils over a larger area.

This application claims priority to Provisional Application No. 62/634,177, filed Feb. 22, 2018, which is incorporated by reference herein in its entirety.

### FIELD OF THE INVENTION

The present invention relates generally to AC electromagnetic tracking systems with point transmitter and point sensor/receiver, employing dipole filed approximation and more particularly to the physical configuration of transmitter coils in such systems.

### BACKGROUND OF THE INVENTION

Electromagnetic tracking systems typically have transmitter coils and sensor coils. See, e.g., U.S. Pat. No. 9,459,124 and H. Himberg, “Latency and Distortion Compensation in Augmented Environment Using Electromagnetic Trackers,” Doctoral Dissertation, 2010, Virginia Commonwealth University, Richmond Va. 23284, USA, and references therein which describe a variety of electromagnetic trackers and their architectures. In the majority of these systems, dipole field approximation is used to determine the position and orientation (“PnO”) of the sensor coils relative to the transmitter coils. See, e.g., Jack B. Kuipers, “Quaternions and Rotation Sequences,” Princeton University Press, 2002, which describes the basics of the six degree of freedom (6DoF) dipole solution. The solution can be obtained from a 3-axis concentric coils transmitter and a 3-axis concentric coils sensor to produce a 3×3 signal matrix, which is a function of transmitter coils drive currents, effective areas of the coils, a transmitter-to-sensor radius vector, and a transmitter-to-sensor rotation matrix (also known as directional cosines or projection matrix).

The closed form of the PnO solution referenced above is based on the transmitter (otherwise known as “transmitting” or “source”) coils being concentric (i.e., the three transmitter coils share the same center) and, separately, the sensor (otherwise known as “sensing”) coils also being concentric (i.e., the three sensor coils share the same center). This is typically shown in the art as in FIG. 1, where the concentric center of the three coils making up the set of transmitter coils is labeled (a, b, c) and the concentric center of the three coils making up the set of sensor or sensing coils is labeled (x, y, z).

There are also known approaches that use co-planar, or almost co-planar coils (See. e.g., those developed by Biosense Webster, Superdimension (Medtronic), and some others). For example, U.S. Pat. No. 6,147,480 describes a tracker with a several separate transmitters and U.S. Pat. No. 5,752,513 describes a tracker with multiple co-planar transmitter coils where the sensor is operating just above the transmitter plane thus confining the operational volume. While these configurations are known in the art they use other physical effects rather than being focused on electromagnetic dipole field 6DoF trackers.

Having concentric transmitter coils in 6DoF AC electromagnetic trackers results in a more bulky physical arrangement than if the coils were not concentric. Such bulkiness can be undesirable in certain applications and can limit nearby placement and/or arrangement of other components.

### SUMMARY OF THE INVENTION

A system and method is disclosed which provides for an electromagnetic tracking having non-parallel, non-concentric transmitter coils and using modified dipole approximation.

One embodiment discloses an electromagnetic tracking system comprising: a plurality of non-concentric, non-parallel transmitter magnetic coils configured to be attached to a user's head and generate a magnetic field; a plurality of concentric, orthogonal sensor magnetic coils configured to sense the magnetic field, and generate magnetic sensor data; and a processor configured to: generate and output instructions to display an image on a display; determine a position and orientation of the sensor magnetic coils using the magnetic sensor data; and generate and output instructions to the display to display on the image on the display the determined position and orientation of the sensor magnetic coils.

### BRIEF DESCRIPTION OF THE DRAWINGS

FIG. 1 is a diagram of a prior art electromagnetic tracking system with three orthogonal, concentric transmitter coils and three orthogonal, concentric sensor coils.

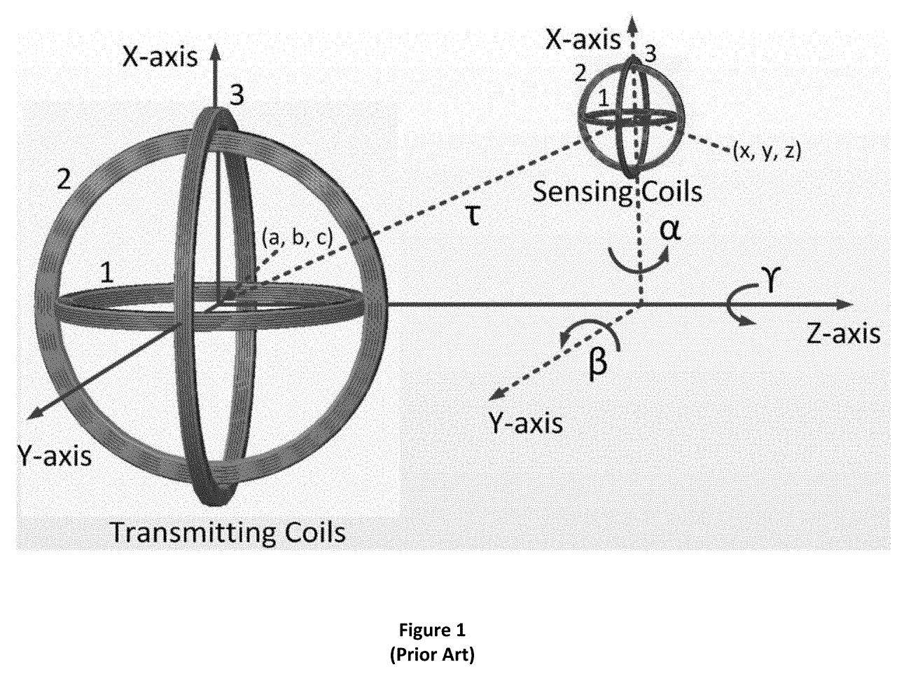

FIGS. 2A and 2B illustrate an embodiment of an electromagnetic tracking system having a three non-parallel, non-concentric coil transmitter arrangement.

### DETAILED DESCRIPTION OF THE INVENTION

Electromagnetic tracking systems having concentric transmitter coils results in a more bulky physical arrangement than if the coils were not concentric. Such bulkiness can be undesirable in certain applications and can limit nearby placement and/or arrangement of other components. What will now be described is an embodiment in which the transmitter (also referred to herein as “transmitting” or “source”) coils, which generate magnetic fields, are instead arranged in a non-concentric fashion such that the transmitter coils do not share a common center. The solution for such a geometry will also be explained.

In one implementation, the three coils of the transmitter are placed on a rigid structure, such as a helmet, cap, or other known headgear, attached to a head mounted display (HMD) and associated with its reference frame. More particularly, in this implementation, the three transmitter coils are placed on the spherical top of the rigid structure.

In this embodiment, the three sensor coils remain concentric and orthogonal to each other, as in prior approaches. Further, the location and placement of the sensor coils can be anywhere with no restrictions as known in the prior art. For example, the sensor coils can be located on a part of the user's body (e.g., trunk and/or limb) and attached to a user or included in a controller (e.g., a handset or tool) in any known fashion and/or as described elsewhere herein.

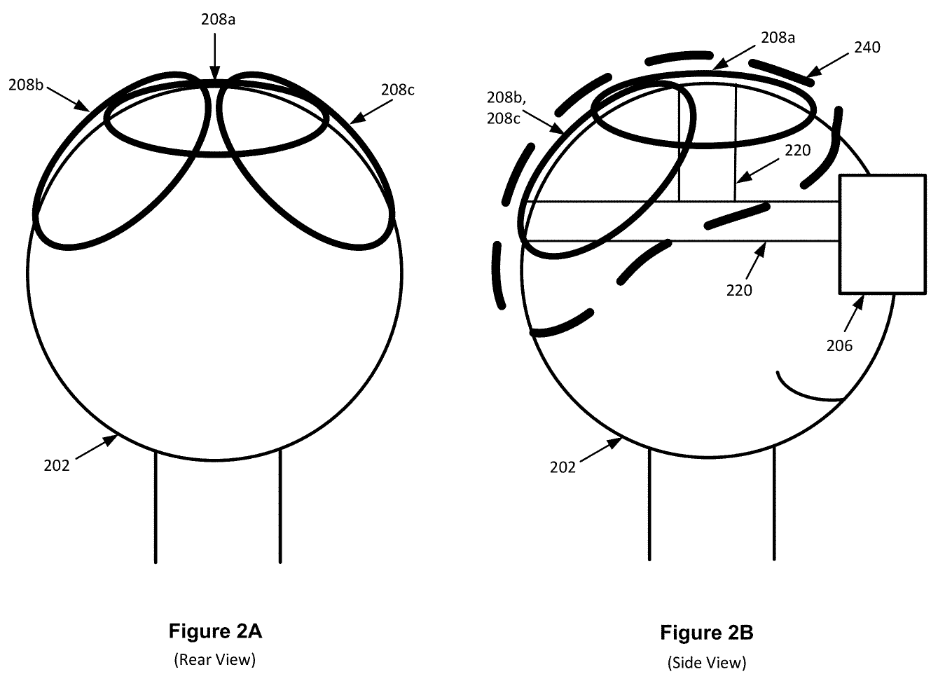

Referring now to FIGS. 2A and 2B, an example implementation of the three non-concentric coil transmitter arrangement can be seen in a rear view, in FIG. 2A, and in a side view, in FIG. 2B. It is to be understood that certain features and elements shown in FIG. 2B are not shown in FIG. 2A so as to avoid obscuring details. In this example, and as shown in FIG. 2B, the user 202 is wearing a head-mounted display (“HMD”) 206 that encompasses part or all of a user's field of view and presents computer generated images representing a virtual or augmented reality environment to the user. One type of HMD presently available is the Oculus Rift from Oculus VR, now owned by Facebook.

Attached to HMD 206 via straps 220 and/or helmet 240 (shown in FIG. 2B in outline form and which may be affixed to HMD 206) are three non-concentric coils (not to scale), labeled 208a, 208b, and 208c. Unlike known transmitter coils and as can be seen in the figures, the three coils 208a, 208b, and 208c are non-concentric in that they do not share a common center point.

Having the three transmitter coils be non-concentric provides a number of benefits. Such an arrangement can reduce the overall bulkiness of the three coils by comparison to a three concentric coil arrangement that consumes a spherical volume defined by the three concentric coils. By contrast, the three non-concentric coils can be placed in different locations and can even allow other components to occupy the space within one or more of the coils as desired in a given configuration.

Another benefit of having three transmitter coils be non-concentric, while still minimizing overall bulkiness, is that the coils can be made physically larger. Increasing transmitter coil size results in a better signal-to-noise ratio using the same power to generate the magnetic field, a desirable thing when the coils are placed near other electronic components or sensitive parts of a user's body such as their head.

Still another benefit of having three transmitter coils be non-concentric, while still minimizing overall bulkiness, is that the combined weight of the three coils can be spread out over a larger area. Spreading out the combined weight of the three coils thus reduces a user's perception of device weight and can make for a more balanced feeling device.

It is to be understood that the attachment of the non-concentric coils to the HMD can be by attaching the coils to any known rigid, spherical structure that provides a fixed, physical relationship between the coils and the HMD. The possible examples of a rigid, spherical structure include a helmet, cap or other hat-like structure. In another example, the non-concentric coils are instead attached to the HMD by being attached directly to the HMD, on the inside or outside of the HMD so long as a fixed, physical relationship is maintained between the coils and the HMD thereby maintaining the association with its reference frame.

In such an embodiment, because the three transmitter coils are non-concentric, the 3×3 signal matrix known and described above cannot be built. Instead, as opposed to the above referenced known methods, consider three separate for each coil electromagnetic induction vectors Bₖ, generated by the transmitter coils k (that is, x, y, or z) at the sensor position rₖ:

$${B}_{k} = {T}_{k} \frac{{IS}_{source} {μ}_{0}}{4 π} \frac{1}{{r}_{k}^{3}} ( 3 ( {e}_{k} \cdot {ρ}_{k} ) {ρ}_{k} - {e}_{k} ) \qquad ( 1 )$$

where I is the transmitter coil's current, S_{source} is an effective area of the transmitter coil (considering that the transmitter coils are identical and driven with the same current), Tₖ is the rotation matrix from the transmitter coil reference frame to the sensor reference frame, rₖ=|rₖ|, ρₖ is the unit vector in the direction of rₖ, eₖ is the unit vector along the axis of k^{th} coil, and μ₀ is the magnetic permeability. For simplicity, I and S_{source} are considered the same for all coils. The equations (1) comprise a set of transfer functions between the transmitter coils and the sensor coils. While three instances of equations (1) cannot be combined into a single signal matrix, instead the following a priori known relationships are used:

T_{y}=T(y←x)·Tₓ; T_{z}=T(x←y)·Tₓ (2)

rₓ=R_{common}+Rₓ; r_{y}=R_{common}+R_{y}; r_{z}=R_{common}+R_{z}; |Rₓ|=|R_{y}|=|R_{z}| (3)

Equations (2), which uses the rotation from one axis to another without restricting rotation to 90 degrees (as was the case with Equations (2) of Provisional Application No. 62/634,177, but which could otherwise be used instead), link the x, y, z components of the sensed signal and (3) describe the relationships between the transmitter coils positions with respect to the center of symmetry, or, in other words, common reference point (R_{common}) that can be chosen conveniently in the proximity of transmitter coils.

As would be understood by one of skill in the art in light of the teachings herein, equations (1)-(3) thus consist of three non-linear vector equations (1), two matrix equations (2) and three linear vector equations (3). These equations are with respect to 6 variables, R_{common} and Tₓ. This can be solved iteratively, using an optimization procedure, a least squares approach, or perturbation theory (starting from the common center solution treated in this case as a location of a hypothetic point source), or a combination of all of the above, again as would be understood by one of skill in the art in light of the teachings herein. It is to be further understood in light of the teachings herein that these determinations can be made by a processor, which can generate and output instructions to a display such as the HMD, as described elsewhere herein.

In a further embodiment, the electromagnetic tracking system comprising non-concentric transmitter coils is combined with a known tracking system. In this further embodiment, the known tracking system can be any known tracking system attached to or included with the HMD as described. Once such known tracking system is an electromagnetic tracking system with one set of coils attached to the HMD and the other set of coils placed at a fixed location such as on a table, with one set of coils being the transmitter coils and the other set of coils being the sensor coils. Another such known tracking system is an optical tracking system. Alternatively, the electromagnetic tracking system comprising non-concentric transmitter coils can be combined with an inertial measurement unit (“IMU”). Yet still another known tracking system is a combined opto-inertial tracking system. In a still further embodiment, rather than combining the electromagnetic tracking system comprising non-concentric transmitter coils with another, known tracking system, instead another sensor having three concentric, orthogonal coils can be placed at a fixed location.

Any such known tracking system, or combination as has been described, and as would be understood by one of skill in the art in light of the teachings herein, can provide the position and orientation of the HMD relative to any of the reference points of the known tracking system. Further, as explained herein, the electromagnetic tracking system comprising non-concentric transmitter coils and orthogonal, concentric sensor coils can provide the position and orientation of the sensor coils relative to the non-concentric transmitter coils. Therefore, in light of the teachings herein, one of skill in the art will also understand that the relative position and orientation of the orthogonal, concentric sensor coils of the alternative electromagnetic tracking system can be determined by combining these two position and orientation determinations.

The disclosed system and method have been explained above with reference to several embodiments. Other embodiments will be apparent to those skilled in the art in light of this disclosure. Certain aspects of the described method and apparatus may readily be implemented using configurations or steps other than those described in the embodiments above, or in conjunction with elements other than or in addition to those described above. It will also be apparent that in some instances the order of steps described herein may be altered without changing the result or performance of all of the described steps.

There may be a single processor, or multiple processors performing different functions of the functions described herein. As above, a processor may be located in the HMD or elsewhere on the user's body, associated with a display device, or even in a central system or base station if desired. One of skill in the art will appreciate how to determine which and how many processors will be appropriate for a specific intended application. Instructions for performing the methods herein on a processor may be stored on a non-transitory computer-readable storage medium.

These and other variations upon the embodiments are intended to be covered by the present disclosure, which is limited only by the appended claims.

What is claimed is:

1. An electromagnetic tracking system comprising:
a plurality of non-concentric, non-parallel transmitter magnetic coils configured to be attached to a user's head and generate a magnetic field;
a plurality of concentric, orthogonal sensor magnetic coils configured to sense the magnetic field, and generate magnetic sensor data; and
a processor configured to:
generate and output instructions to display an image on a display;
determine a position and orientation of the sensor magnetic coils using the magnetic sensor data;
and
generate and output instructions to the display to display on the image on the display the determined position and orientation of the sensor magnetic coils.

2. The system of claim 1, wherein the plurality of non-concentric, non-parallel transmitter magnetic coils configured to be attached to the user's head does so by being attached to a rigid, spherical structure.

3. The system of claim 2 wherein the rigid, spherical structure is one of a helmet, cap, or other hat-like structure.

4. The system of claim 1, wherein the plurality of non-concentric, non-parallel transmitter magnetic coils configured to be attached to the user's head is contained in a head mounted display (HMD).

5. The system of claim 1, wherein the plurality of concentric, orthogonal sensor magnetic coils are configured to be attached to a part of the user's body.

6. The system of claim 5 wherein the part of the user's body is a limb of the user.

7. The system of claim 7, wherein the part of the user's body is a torso of the user.

8. The system of claim 5 wherein the plurality of concentric, orthogonal sensor magnetic coils configured to be attached to a part of the user's body is contained in a controller configured to be held by or attached to the user.
